(19) United States
(12) Patent Application Publication
(10) Pub. No.: US 2007/0043868 A1
(43) Pub. Date: Feb. 22, 2007

(54) System and method for searching for network-based content in a multi-modal system using spoken keywords

(75) Inventors: Sunil Kumar, San Diego, CA (US); Chandra Kholia, San Diego, CA (US); Dipanshu Sharma, San Diego, CA (US); Subramamya R. Uppala, San Diego, CA (US)

Correspondence Address: COOLEY GODWARD KRONISH LLP, 3000 EL CAMINO REAL, 5 PALO ALTO SQUARE, PALO ALTO, CA, 94306, US

(73) Assignee: V-ENABLE, INC., San Diego, CA (US)

(21) Appl. No.: 11/482,527

(22) Filed: Jul. 7, 2006

Related U.S. Application Data
(60) Provisional application No. 60/697,602, filed on Jul. 7, 2005.

(51) Int. Cl. G06F 15/16; G06F 15/173

(52) U.S. Cl. 709/226; 703/12; 709/230

(57) ABSTRACT

A speech-based method of searching for network content is disclosed. The method includes receiving, at a portable communication device, speech input containing a keyword. Data representative of the speech input is then sent by the portable communication device to a server. The method further includes receiving, at the portable communication device, information relating to a plurality of candidate results corresponding to the keyword. A list of selectable links through which network-based content associated with the plurality of candidate results may be accessed is then displayed through an interface of the portable communication device.

### CROSS-REFERENCE TO RELATED APPLICATIONS

This application claims priority under 35 U.S.C. §119(e) to U.S. provisional application Ser. No. 60/697,602, entitled A SYSTEM FOR SEARCHING THE CONTENT BY SPEAKING IN KEYWORDS, filed Jul. 7, 2005. This application is also related to co-pending U.S. patent application Ser. No. 10/040,525, entitled INFORMATION RETRIEVAL SYSTEM INCLUDING VOICE BROWSER AND DATA CONVERSION SERVER, to co-pending U.S. patent application Ser. No. 10/336,218, entitled DATA CONVERSION SERVER FOR VOICE BROWSING SYSTEM, to co-pending U.S. patent application Ser. No. 10/349,345, entitled MULTI-MODAL INFORMATION DELIVERY SYSTEM, and to co-pending U.S. patent application Ser. No. 10/830,413, entitled GATEWAY CONTROLLER FOR A MULTIMODAL SYSTEM THAT PROVIDES INTER-COMMUNICATION AMONG DIFFERENT DATA AND VOICE SERVERS THROUGH VARIOUS MOBILE DEVICES, AND INTERFACE FOR THAT CONTROLLER, filed Apr. 21, 2004, each of which is incorporated herein by reference in its entirety.

### FIELD OF THE INVENTION

The present invention relates generally to the field of multi-modal communications and, more particularly, to a multi-modal system and method of searching for content stored in a network (e.g., the Internet) by providing speech queries to a portable or other communication device capable of communicating with a gateway server having access to various network-based content sources.

### BACKGROUND OF THE INVENTION

The Internet has revolutionized the way people communicate. As is well known, the World Wide Web, or simply “the Web”, is comprised of a large and continuously growing number of accessible Web pages. In the Web environment, clients request Web pages from Web servers using the Hypertext Transfer Protocol (“HTTP”). HTTP is a protocol which provides users access to files including text, graphics, images, and sound using a standard page description language known as the Hypertext Markup Language (“HTML”). HTML provides document formatting and other document annotations that allow a developer to specify links to other servers in the network.

A Uniform Resource Locator (URL) defines the path to Web site hosted by a particular Web server. The pages of Web sites are typically accessed using an HTML-compatible browser (e.g., Netscape Navigator or Internet Explorer) executing on a client machine. The browser specifies a link to a Web server and particular Web page using a URL.

The ability to relatively easily search for Web content has been an important factor in successful evolution of the Internet. Billions of pages can be searched in few a seconds through the search engines such as Google, Yahoo and the like. Although these Web search facilities have tend to work well in conventional PC environments, but have failed to create the same impact in the mobile environment where Web access occurs through a mobile phone or other portable device. This is due in part to characteristics of mobile devices and to the nature of current search engines, which are not tailored for mobile users.

In general, it is more difficult to type or otherwise enter search queries through existing user interfaces of mobile devices than through conventional PC arrangements. In particular, typed entry of keyword information into mobile devices requires special techniques which tend to be time-consuming and cumbersome. This in turn limits the content navigation through a search engine. As many users of mobile users tend to be savvy consumers of a variety of a variety of different types of content (e.g., personalized stock information, music, ringtones, wallpapers, games, news, movies, etc.), the difficulty experienced by users in accessing such content through mobile devices may tend to limit its usage.

Although voice-based systems exist for enabling users of portable devices to browse certain Web content, such systems are unsuitable for use in cases in which an appreciable amount of information is provided to the user during the browsing process. In particular, the user may have difficulty in comprehending or remembering the information delivered or storing it for future reference.

### SUMMARY OF THE INVENTION

The present invention relates in one aspect to a speech-based search method conducted through an interface provided by a portable communication device. The method includes receiving, at the portable communication device, speech input containing a keyword. Data representative of the speech input is then sent by the portable communication device to a server. The method further includes receiving, at the portable communication device, information relating to a plurality of candidate results corresponding to the keyword. A list of selectable links through which network-based content associated with the plurality of candidate results may be accessed is then displayed through an interface of the portable communication device.

In another aspect the present invention pertains to a method in which speech input containing a keyword is received at a portable communication device. The method includes sending, from the portable communication device, data representative of the speech input to a server. Content from a network which corresponds to the keyword is then received at the portable communication device. The method further includes rendering, through a display of the portable communication device, a visual representation of the content.

The present invention is also directed to a method in which there is received at a gateway server input data from a portable communication device, wherein the input data is representative of speech input previously received by the portable communication device. The method includes processing the input data to identify one or more input keywords. The method further includes identifying, based upon the one or more input keywords, a plurality of candidate results potentially corresponding to the one or more input keywords. The gateway server then sends, to the portable communication device, information enabling display of a list of selectable links through which network-based content associated with the plurality of candidate results may be accessed.

In another aspect the invention pertains to a method involving receiving, at a gateway server, input data from a portable communication device representative of speech input received by the portable communication device. Upon receipt, the input data is processed to identify one or more input keywords. The method further includes identifying, based upon the one or more input keywords, content corresponding to the one or more input keywords. The method further includes issuing, to a content server, a request for the content. The gateway server then sends, to the portable communication device, the content for display.

In yet another aspect the invention relates to a portable communication device comprising a communication portion and a user interface portion. The communication portion operates to allow receiving of speech input containing a keyword, sending data representative of the speech input to a server, and receiving of information relating to a plurality of candidate results corresponding to the keyword. The user interface portion contains a display capable of rendering a list of selectable links through which network-based content associated with the plurality of candidate results may be accessed.

The present invention also pertains to a portable communication device comprising a communication portion and a user interface portion. The communication portion operates to allow receiving of speech input containing a keyword, sending data representative of the speech input to a server, and receiving content from a network corresponding to the keyword. The user interface portion contains a display capable of rendering a visual representation of the content.

A further aspect of the invention is directed to a gateway server comprising a communication portion and a processing portion. The communication portion operates to allow the receiving of input data from a portable communication device representative of speech input received by the portable communication device. The processing portion is configured to process the input data to identify one or more input keywords and identify, based upon the one or more input keywords, a plurality of candidate results potentially corresponding to the one or more input keywords. The communication portion is further configured to send information to the portable communication device enabling display of a list of selectable links through which network-based content associated with the plurality of candidate results may be accessed.

An additional aspect of the invention relates to a method comprising receiving speech input through an audiovisual interface of a communication device. The method also includes displaying, through the audiovisual interface, content acquired from a network based upon the speech input.

Yet another aspect of the invention pertains to a gateway server which includes a communication portion through which is received input data from a portable communication device representative of speech input provided to the portable communication device. The gateway server further includes a set of resource adapters configured to maintain a plurality of initialized network connections with a corresponding plurality of external servers. A gateway controller is operative to assign the input data to one of the initialized network connections. In addition, the communication portion is also disposed to send information corresponding to the input data to one of the external servers over the one of the initialized network connections.

### BRIEF DESCRIPTION OF THE DRAWINGS

For a better understanding of the nature of the features of the invention, reference should be made to the following detailed description taken in conjunction with the accompanying drawings, in which:

FIG. 1 shows a high level architecture of a Multimode Gateway Controller (MMGC) and the interaction of the MMGC with different information gateways.

FIG. 2 shows the architecture of a veANYWAY solution in a carrier environment.

FIG. 3 illustrates a high level architecture of various modules of a veGATEWAY server with respect to a Vodka interface between the veGATEWAY server and a corresponding client-side application, i.e., veCLIENT.

FIG. 4 illustratively contrasts the tree-based navigation occurring during a conventional browsing session using a mobile device with a speech search-based approach consistent with the invention.

FIGS. 5-6 are flowcharts representative of the operations respectively performed by the veCLIENT and the veGATEWAY of a speech-based search system.

FIGS. 7 and 8 illustrate a typical usage scenario consistent with an embodiment of the speech search method of the present invention.

FIG. 9 illustrates the simultaneous visual presentation to a user of a set of N-best probable candidate search results corresponding to a spoken search query.

FIG. 10 illustratively represents the architecture of a portable communication device platform designed to facilitate the speech search functionality contemplated by the present invention.

FIGS. 11A-11C provide illustrative representations of various adapter architectures capable of being utilized within the veGATEWAY server.

FIG. 12 illustrates the architecture of a system including a collection of components involved in maintaining a speech search application.

FIG. 13 provides a high-level overview of the architecture of a multi-modal client-server system 1300 in which a connection resource pooling approach may be implemented.

FIG. 14 is a state diagram illustrating various aspects of a server-side resource pooling approach consistent with the present invention.

### DETAILED DESCRIPTION OF EMBODIMENTS OF THE INVENTION

### System Overview

The present disclosure describes methods for searching for network-based content on a keyword basis using speech. Performing searching operations in a speech mode enables search queries to be spoken rather than entered through a conventional keyboard or keypad. This offers particular advantages relative to the case of text entry into mobile devices, which tends to be time-consuming and cumbersome. It is a feature of embodiments of the invention that although search queries may be spoken, search results may be presented to the user in visual form through a text-based or graphical user interface of the device to which the spoken query is provided.

In order to provide an understanding of an exemplary system environment in which embodiments of the invention may be implemented, a summary description is provided of the Multimode Gateway Controller and associated operating environment as described in the above-referenced U.S. patent application Ser. No. 10/830,413 (the “'413 application”). The Multimode Gateway Controller of the '413 application enables a device to communicate with different information gateways simultaneously, in different modes while keeping the user session active, as a form of Inter-Gateway Communication. Each of the modes can be a communication mode supported by a mobile telephone, and can include, for example, voice mode, text mode, data mode, video mode, and the like. The Multimode Gateway Controller (MMGC), also referred to hereinafter as the “veGATEWAY”, enables a device to communicate with other devices through different forms of information.

The MMGC provides a session using session initiation protocol, “SIP” to allow the user to interact with different information gateways one at a time or simultaneously, depending on the capability of the device. This provides an application that renders content in a variety of different forms including voice, text, formatted text, animation, video, WML/xHTML or others.

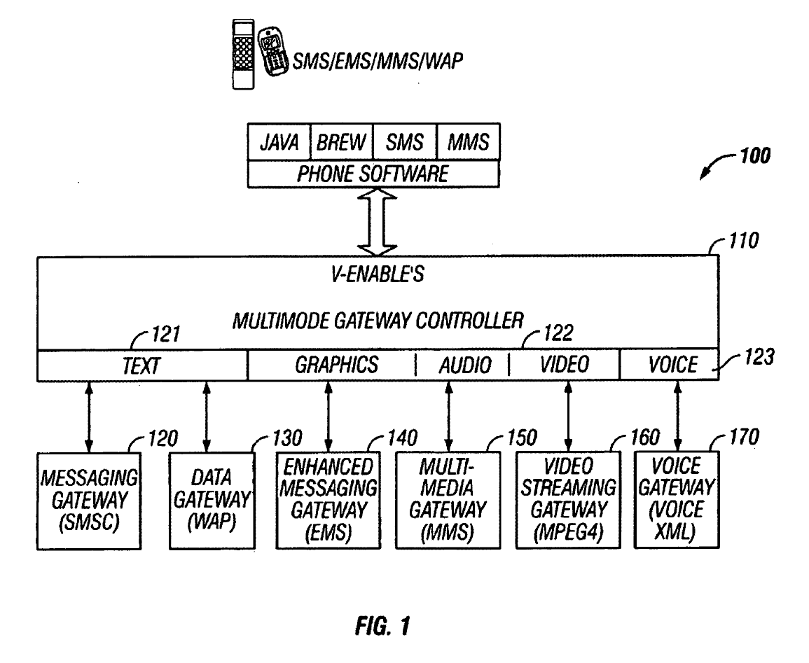

FIG. 1 shows a high level architecture of the MMGC, showing the interaction of the MMGC with different information gateways.

The Multimode Gateway may reside at the operator (carrier) infrastructure along with the other information gateways. This may reduce latency that is caused while interfacing with different gateways.

There are believed to be more than a billion existing phones which have messaging (SMS) and voice capability. All of those phones are capable of using the MMGC 110 of FIG. 1. Interacting with this gateway allows these phones to send an SMS message while in a voice session.

G devices with SMS functionality can interface with the SMS gateway and the VoiceXML gateway. This means that basically all current phones can use the MMGC. The functionality proliferates as the installed base of phones move from lower end 2G devices to higher end 3G devices. The more highly featured devices allow the user to interface with more than just two gateways through MMGC.

FIG. 1 shows the Gateway controller 110 interfacing with a number of gateways including a messaging Gateway 120, a data Gateway 130, e.g. one which is optimized for WAP data, an enhanced messaging Gateway 140 for EMS communications, an MMS type multimedia Gateway 150, a video streaming Gateway 160 which may provide MPEG 4 type video, and a voice Gateway 170 which may operate in VoiceXML. Basically, the controller interfaces with the text gateways through text interface 121, that interfaces with the messaging Gateway 120 and the data Gateway 130. A multimedia interface 122 provides interface with the graphics, audio and video gateways. Finally, the voice interface 123 provides an interface with the voice Gateway.

In operation, a 3G device with simultaneous voice and data capability can receive a video stream through a Video gateway 160, such as Packet Video, while still executing a voice based application through a VoiceXML gateway 170 over the voice channel.

The veANYWAY solution can be used on variety of device types ranging from SMS only devices, to advanced devices with the Java/Brew/Symbian/Windows CE etc. platform. This veANYWAY solution moves from a server only solution to a distributed solution as the devices move from SMS only devices to more intelligent devices with Java/Brew/Symbian/Windows CE capability. With intelligent devices, a part of an application can be processed at the client itself, thus increasing the usability and reducing the time involved in bringing everything from the network.

The veANYWAY solution communicates with the various information gateways using either a Distributed approach or a Server only approach.

In the distributed approach, the veCLIENT and veGATEWAY form two components of the overall solution. With an intelligent device, the veCLIENT becomes the client part of the veANYWAY solution and provides a software development kit (SDK) to the application developer which allows the device to make use of special functionality provided by the veGATEWAY server.

In the case of browser only devices where no software can be downloaded, the browser itself acts as the client and is configured to communicate with the veGATEWAY 100. The veGATEWAY 110 on the server side provides an interface between client and the server. A special interface and protocol between veCLIENT and the veGATEWAY is known as the Vodka interface.

If the veCLIENT can be installed on the mobile device, it allows greater flexibility and also reduces the traffic between client and server. The veCLIENT includes a multimodal SDK which allows developers to create multimodal applications using standards such as X+V, SALT, W3C multimode etc and also communicates with the veGATEWAY 112 at the server. The communication with the veGATEWAY is done using XML tags that can be embedded inside the communication. The veCLIENT processes the XML tags and makes appropriate communication with the veGATEWAY. In case of a browser only client, these XML tags can either be processed by the veCLIENT or by the veGATEWAY server. The veCLIENT component also exports high-level programming APIs (java/BREW/Symbian/Windows CE etc.) which can be used by the application developers to interact with the veGATEWAY (instead of using XML based markup) and use the services provided by veGATEWAY.

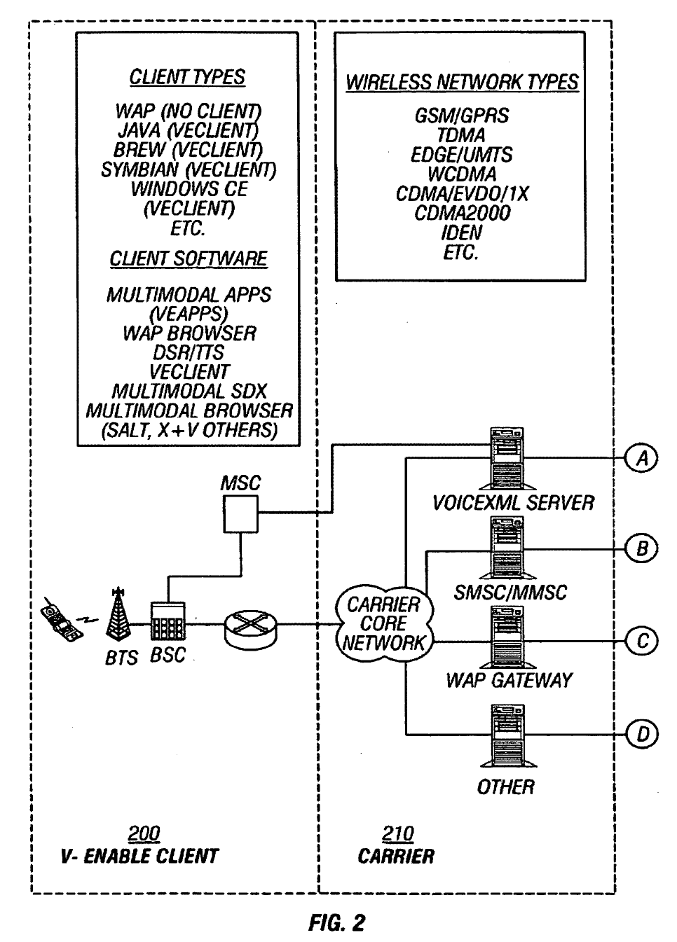

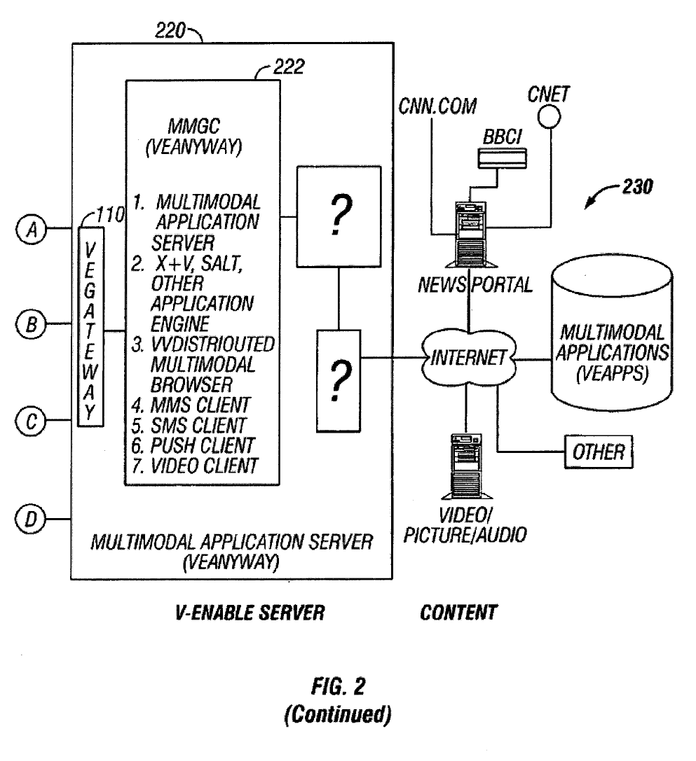

FIG. 2 shows the architecture of the veANYWAY solution in a carrier environment. The structure in FIG. 2 has four main components.

First, the V-Enable Client (veCLIENT) 200 is formed of various sub-clients as shown. The clients can be “dumb” clients such as SMS only or Browser Only clients (WAP, iMode etc.) or can be intelligent clients with installed Java, Brew, Symbian, Windows platforms that allow adding software on the device. In case of dumb clients, the entire processing is done at the server and only the content is rendered to the client.

In case of an intelligent client, a veCLIENT module is installed on the client, which provides APIs for application developers. This also has a multimodal browser that can process various multimodal markups in the communication (X+V, SALT, W3C Multimodal 1) in conjunction with the multimodal server (veGATEWAY). The veCLIENT also provides the XML tags to the applications, to communicate with the information Gateways special veAPPS form the applications which can use the veCLIENT functionality.

The Carrier Network 210 component forms the communication infrastructure needed to support the veANYWAY solution. The veANYWAY solution is network agnostic and can be implemented on any type of carrier network e.g., GSM, GPRS, CDMA, UTMS etc.

The V-Enable Server 220 includes the veGATEWAY shown in FIG. 1. It provides interfaces with other information gateways. The veGATEWAY also includes a server side Multimodal Browser which can process the markups such as SALT, X+V, W3C multimodal etc. It also processes the V-enable markups, which allows a browser only client to communicate with certain information gateways such as SMS, MMS, WAP, VoiceXML etc in the same session. For intelligent thin clients, the V-Enable markup is processed at the client side by the veCLIENT.

The server (veGATEWAY) also includes clients 222, which may include a MMS Client, SMS Client, and WAP Push Client which is required in order to process the request coming from the devices. These clients connect with the appropriate gateways via the veGATEWAY, sequentially or simultaneously, to deliver the information to the mobile device.

The content component 230 includes the various different forms of content that may be used by the veANYWAY solution for rendering. The content in multimodal form can include news, stocks, videos, games etc.

Again, the communication between the veCLIENT and veGATEWAY uses a special interface, called the Vodka interface, which provides the necessary infrastructure needed for a user to run a Multimodal application. The Vodka interface allows applications to access appropriate server resources simultaneously, such as speech, messaging, video, and any other needed resources.

The veGATEWAY provides a platform through which a user can communicate with different information gateways as defined by the application developer. The veGATEWAY provides necessary interfaces for the inter-gateway communication. However, these interfaces must be used by an application efficiently, to render content to the user in different forms. The veGATEWAY interfaces can be used with XML standards such as VoiceXML, WML, xHTML, X+V, and SALT. The interfaces provided by veGATEWAY are processed in a way so that they take the form of the underlying native XML markup language. This facilitates the application production by the developer, without worrying about the language they are using. The veGATEWAY interprets the underlying XML language and processes it accordingly.

In an embodiment, the interfaces are in the form of XML tags which can be easily embedded into the underlying XML language such as VoiceXML, WML, XHTML, SALT, X+V. The tags instruct the veGATEWAY on how to communicate with the respective information gateway and maintain the user session while across the different gateways. The XML tags can be replaced by the API interface for a conventional application developer who uses high-level languages for developing applications. The conventional API interface is especially useful in case of intelligent clients, where applications are partially processed by the veCLIENT. The application developers can use either XML tags or APIs, without changing the functionality of the veGATEWAY.

The following discussion describes XML markup tags as the interface being used, understanding that the concept can be ported to an API based interface, without changing the semantics.

The communication with different information gateways may require the user to switch modes from data to voice or from voice to data, based on the capability of the device. Devices with simultaneous voice and data capability may not have to perform that switching mode. However, devices incapable of simultaneous voice and data may switch in order to communicate with the different gateways. While this switch is made, the veGATEWAY maintains the session of the user.

A data session is defined as when a user communicates with the content. The communication can use text/video/pictures/keypad or any other user interface. This could be either done using the browsers on the phone or using custom applications developed using JAVA/BREW/SYMBIAN. The data can SMS, EMS, MMS, PUSH, XHTML, WML or others.

Using WAP browsers to browse web information is another form of a data session. Running any network-based application on a phone for data transaction is also a form of a data session. A voice session is one where the user communicates using speech/voice prompts as the medium for input and output. Speech processing may be done at the local device or on the network side. The data session and voice session can be active at the same time or can be active one at a time. In both cases, the synchronization of data and voice information is done by the server veGATEWAY at the server end.

The following XML tags can be used with any of the XML languages.

Note: The names of the tags used herein are exemplary, and it should be understood that the names of the XML tags could be changed without changing their semantics.

<switch>

The <switch>tag is used to initiate a data session while the user is interacting in a voice session (e.g., while executing a voice based application such as VoiceXML). The initiation of a data session may result in termination of a currently active voice session if the device does not support simultaneous voice and data session. Where the device supports simultaneous voice and data, the veGATEWAY opens a synchronization channel between the client and the server for synchronization of the active voice and data channel. The <switch> XML tag directs the veGATEWAY to initiate a data session; and upon successful completion of data initiation, the veGATEWAY directs the data session to pull up a visual page. The visual page source is provided as an attribute to the <switch> tag. The data session could be sending WML/xHTML content, MMS content, EMS message or an SMS message based on the capability of the device and the attributes set by the user.

The execution of the <switch> may just result in plain text information to be sent to the client and allow the veCLIENT to interpret the information. The client/server can agree on a protocol for information exchange in this case.

One of the examples for sending plain text information would include filling in fields in a form using voice. The voice session recognizes the input provided by the user using speech and then sends the recognized values to the user using the data session to display the values in the form.

The <switch> tag can also be used to initiate a voice session while in a visual session. The initiation of the voice session may result in the termination of a currently active visual session if the device does not support simultaneous voice and data session. In case of a device supporting simultaneous voice and data, the veGATEWAY opens up a synchronization channel between the client and the server for synchronization of the active voice and data channel. The XML <switch> tag directs the veGATEWAY to initiate a voice session, and upon successful completion of voice initiation, the veGATEWAY directs the voice session to pull up a voice page.

The voice source may be used as an attribute to the <switch> tag. The voice session can be started with a regular voice channel provided by the carrier or could be a voice channel over the data service provided by the carrier using SIP/VoIP protocols.

The <switch> tag may have a mandatory attribute URL. The URL can be:

1. VoiceXML source

2. WML source

3. XHTML source

4. other XML source

The MMGC converts the URL into an appropriate form that can be executed using a VoiceXML server. This is further discussed in our co-pending application entitled DATA CONVERSION SERVER FOR VOICE BROWSING SYSTEM, U.S. patent application Ser. No. 10/336,218, filed Jan. 3, 2003.

Whether the user switches from data to voice or voice to data, the veGATEWAY adds capability in a specified content so that the user can return to the original mode.

The <switch> interface maintains the session while a user toggles between the voice and data session. The <switch> results in a simultaneously active voice and data session if the device provides the capability.

Besides sending plain text information, the data or voice session can carry an encapsulated object. The object can represent the state of the user in current session, or any attributes that a session wishes to share with other sessions. The object can be passed as an attribute to the <switch> tag.

Whether the user is in a data session or in a voice session, the user can use the following interfaces to send information to the user in different forms through the veGATEWAY. Of course, this can be extended to use additional XML based tags, or programming based APIS.

<sendsms>

The <sendsms> tag is used to send an SMS message to the current user or any other user. Sending SMS to the current user may be very useful in certain circumstances, e.g., while the user in a voice session and wants to receive the information as a SMS. For example, a directory assistance service could provide the telephone number as an SMS rather than as voice.

The <sendsms> tag directs the MMGC to send an SMS message. The takes the mobile identification number (MIN) and the SMS content as its input, and sends an SMS message to that MIN. The veGATEWAY identifies the carrier of the user based on the MIN and communicates appropriately with the corresponding SMPP server for sending the SMS.

The SMS allows the user to see the desired information in text form. In addition to sending an SMS, the veGATEWAY adds a voice interface, presumably a PSTN telephone number, in the SMS message. The SMS phones have the capability to identify a phone number in a SMS and to initiate a phone call. The phone call is received by the veGATEWAY and the user can resume/restart its voice session e.g. the user receives an SMS indicating receipt of a new email, and the user dials the telephone number in the SMS message, to listen to all the news emails in voice form.

<sendems>

The <sendems> tag is used to send an EMS message to the current user or to any other user. Sending EMS to the current user is useful when a user is in a voice session and wants to receive the information as an EMS e.g. in a directory assistance service. The user may wish to receive the address as an SMS rather than listening to the address. The XML tag directs the MMGC to send an EMS message. The <sendems> takes the mobile identification number and EMS content as input and sends an SMS message to that MIN. The veGATEWAY also identifies the carrier of the user and communicates appropriately with the corresponding SMPP server. The EMS allows user to see the information in text form.

As above, the veGATEWAY may also add a voice interface, e.g., a telephone number in the EMS message. The EMS phones have capability to identify a phone number in an EMS and initiate a phone call. The phone call is received by the veGATEWAY and the user can resume/restart its voice session e.g. the user receives an EMS indicating receipt of a new email and the user dials the telephone number in the EMS message automatically to listen to the news emails in voice.

<sendmms>

<sendmms> tag is used to send an MMS message to the current user or to any other user. The XML tag directs the veGATEWAY to send an MMS message. The <sendmms> takes the mobile identification number and MMS content as input and sends an MMS message to that MIN. As above, the veGATEWAY based on the MIN identifies the carrier of the user and communicates appropriately with the corresponding MMS server. The MMS allows the user to see information in text/graphics/video form. In addition to sending an MMS, the veGATEWAY adds a voice interface e.g., a telephone number, in the MMS message. The MMS phones have capability to identify a phone number in a MMS and to initiate a phone call. The phone call is received by the veGATEWAY and the user can resume/restart its voice session e.g. the user receives an MMS indicating he received a new email and user dials the telephone number in the MMS message automatically to listen to the news emails in voice.

<sendpush>

The <sendpush> tag is used to send a push message to the current user or to any other user. The XML tag directs the veGATEWAY to send a push message. The <sendpush> takes the mobile identification number and URL of the content as the input to it and sends a push message to the user identified by the MIN. The veGATEWAY gateway identifies the carrier of the user and communicates appropriately with the corresponding push server.

The veGATEWAY identifies the network of the user, e.g., 2G, 2.5G or 3G and delivers the push message by communicating with the corresponding network in an appropriate way. The WAP push allows the user to see the information in text/graphics form. Besides sending a WAP PUSH, the veGATEWAY adds a voice interface, e.g., a telephone number in the PUSH content message. The WAP phones have capability to initiate a phone call while in a data session. The phone call is received by the veGATEWAY and allows user to resume/restart its voice session.

<sendvoice>

The <sendvoice> tag is used to send voice content (e.g., in VoiceXML form) to the current user or to any other user. This XML tag directs the veGATEWAY to initiate a voice session and to execute specified voice content. This tag is especially useful for sending voice based notifications. The voice session can be either initiated by either using the PSTN calls or using SIP based calls.

The above-described XML tags can be used to send information to the other users or current user while a user is in a multimodal session. Each of these tags adds a voice interface or data interface in the content that they send. The voice interface enables to start a voice session while user is in a data mode and vice-versa. These tags are either processed at the client by veClient software or are processed by veGATEWAY server at the server end based on the client capability.

### Vodka Interface

As mentioned above, an intelligent device (e.g., a Brew/Symbian/J2me enabled handset) has two components of the veGATEWAY multimodal solution (Distributed approach), the veCLIENT and the veGATEWAY. The veGATEWAY, server part of the solution, provides a platform using which allows the user/client to communicate with different information gateways as defined by the application developer. The veCLIENT forms the client part of the solution, and has the multimodal SDK that can be used by the application developer to use the functionality provided by the veGATEWAY server, to develop multimodal applications.

veGATEWAY uses resource adapters/interfaces to communicate with various information gateways on behalf of the user/client to efficiently render content to the user/client in different form. The interface between the veCLIENT and veGATEWAY is called the Vodka interface. This is based on the standard SIP and RTP protocols.

The SIP (Session Initiation Protocol) component of the Vodka interface is used for user session management. The RTP (Real-time Transport Protocol) component is used for transporting data with real-time characteristics, such as interactive audio, video or text.

The client opens a data channel with the veGATEWAY and uses the SIP/RTP based Vodka interface to request the veGATEWAY to communicate with one or more information gateways on its behalf. Both the voice and data packets, if required by the application, can be multiplexed over the same channel using RTP avoiding the need for a separate voice channel.

The Vodka SIP interface supports standard SIP methods such as REGISTER, INVITE, ACK and BYE on a reliable transport media such as TCP/IP channel. The REGISTER method is used to by the user/client to register with the veGATEWAY server (veGateway). The veGATEWAY server does some basic user authentication at the time of registration to validate the user credentials. After registering with the veGATEWAY server, the user/client may initiate one or more sessions to communicate with one or more information gateways as required by the user application.

The INVITE method is used by the client to initiate a new session with the veGATEWAY server to communicate with any one of the information gateways as required by the user application. The information gateway is to be used for a session is specified using SDP (Session Description Protocol), in the form “a=X-resource_type:” and “a=X-resource_name:: param_name1=param_value1; param_name2=param_value2; . . . ” in the INVITE method body. The ACK method is used by the client to acknowledge the session setup procedure. The BYE method is used to terminate an established session.

For example if user application/client needs to access two information gateways after registering with the veGATEWAY server, the user application would initiate two sessions using the SIP INVITE method.

The Vodka RTP interface supports a new multimodal RTP profile on a reliable transport medium such as TCP/IP channel. The RTP multimodal profile defines a new payload type and set of events namely VE_REGISTER_CLIENT, VE_CLIENT_REGISTERED, VE_PLAY_PROMPT, VE_PROMPT_PLAYED, VE_RECORD, VE_RECORDED, VE_GET_RESULT and VE_RESULT. These events are used by the user application/client with in a session to request the veGATEWAY server to communicate with the information gateway defined for this particular session, during session establishment procedure using SIP INVITE method, to play voice prompts or get voice recognition results or text search results or the like.

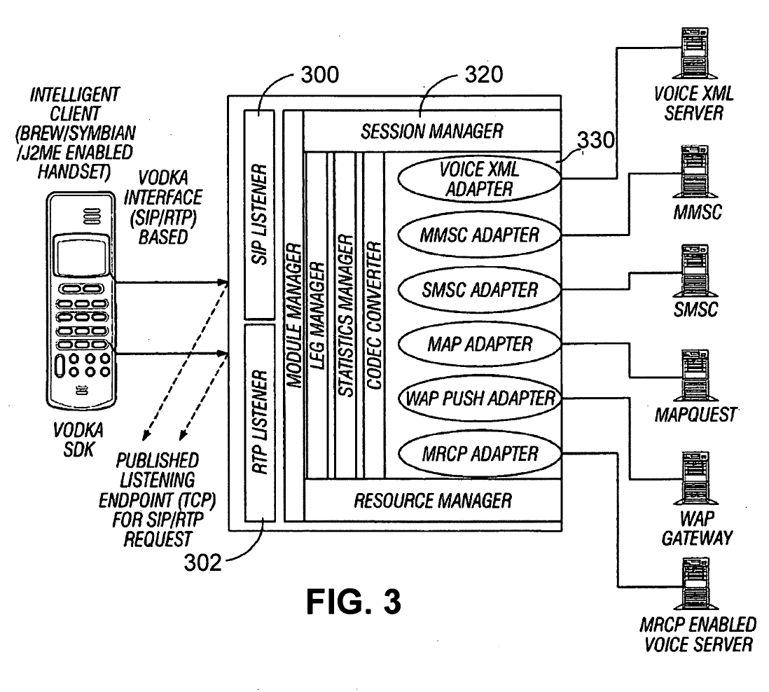

A high level architecture and brief description of various modules of veGATEWAY server with respect to the Vodka interface is shown in FIG. 3.

The listener is formed of an SIP listener 300, and an RTP listener 302. These listen for new TCP/IP connection requests from the client on published SIP/RTP ports, and also poll existing TCP channels (both SIP/RTP) for any new requests from the client.

The module manager 310 provides the basic framework for the veGATEWAY server. It manages startup, shutdown of all the modules and all inter module communication.

A session manager 320 and resource manager 322 maintains the session for each registered client. They also maintain a mapping of which information gateway has been reserved for the session and the valid TCP/IP connections for this session. Based on this information, requests are routed to and from the appropriate information gateway specific adapters. Parsing and formatting of SIP/RTP/SDP messages is also done by this module.

One or more information gateway specific adapters/interfaces 330 are configured in the veGATEWAY server. These adapters abstract the implementation specific details of interaction with a specific information gateway e.g., the VoiceXML server, ASR server, TTS server, MRCP server, MMSC, SMSC, WAP gateway from the client. The adapters translate generic requests from the client to information gateway specific requests, thereby allowing the client to interact with any information gateway using the predefined Vodka interface.

### Basic System Functionality

The disclosed system and method focus upon on providing an effective solution to the problem of efficiently searching for content to be displayed or otherwise presented by a mobile device. Embodiments of the invention provide a speech search method which allows a user to speak a keyword and directly “jump” to the content the user is seeking rather than being required to navigate through a tree-based menu structure. Such conventional navigation may require, for example, typing a search query or receiving a list of links to results requiring multiple additional “clicks” and associated navigation prior to actually reaching the desired content.

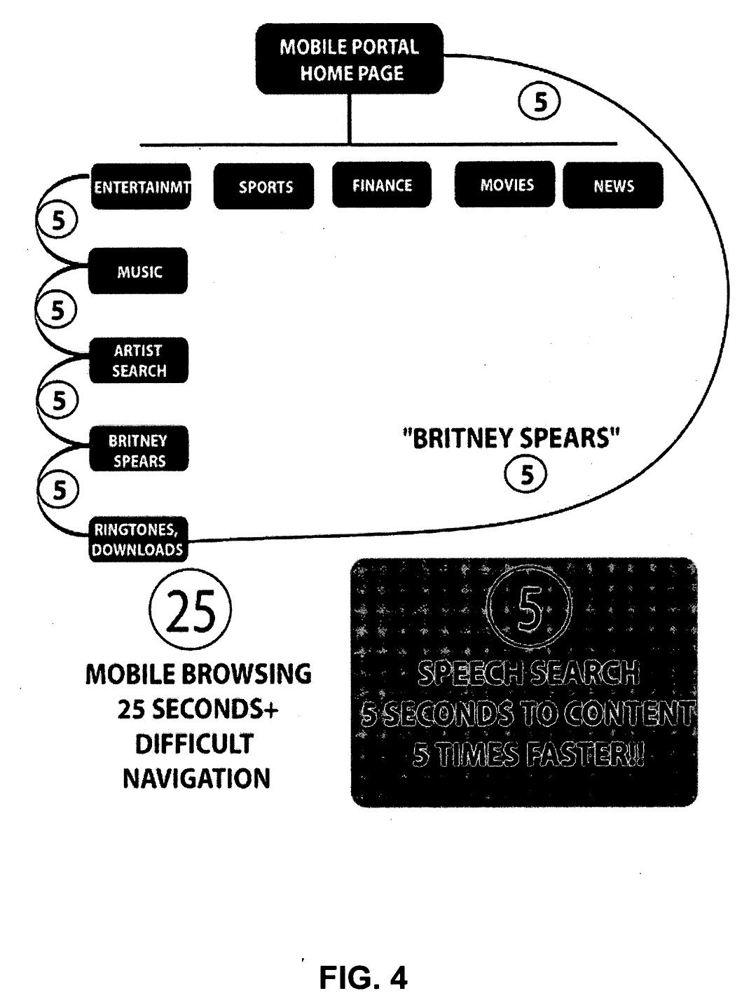

FIG. 4 illustratively contrasts the tree-based navigation occurring during a conventional browsing session using a mobile device with a speech search-based approach consistent with the invention. As shown, navigating from a home page displayed by a browser of a mobile device typically requires navigation through multiple screens and menus until the page containing the desired content is reached. Since each menu or screen transition may require a number (e.g., 5) of seconds, a nontrivial aggregate amount of time may be spent browsing prior to reaching the desired content. In contrast, embodiments of the speech search method of the invention enable the desired content to be accessed in a more direct manner, thus potentially substantially reducing the required browsing time.

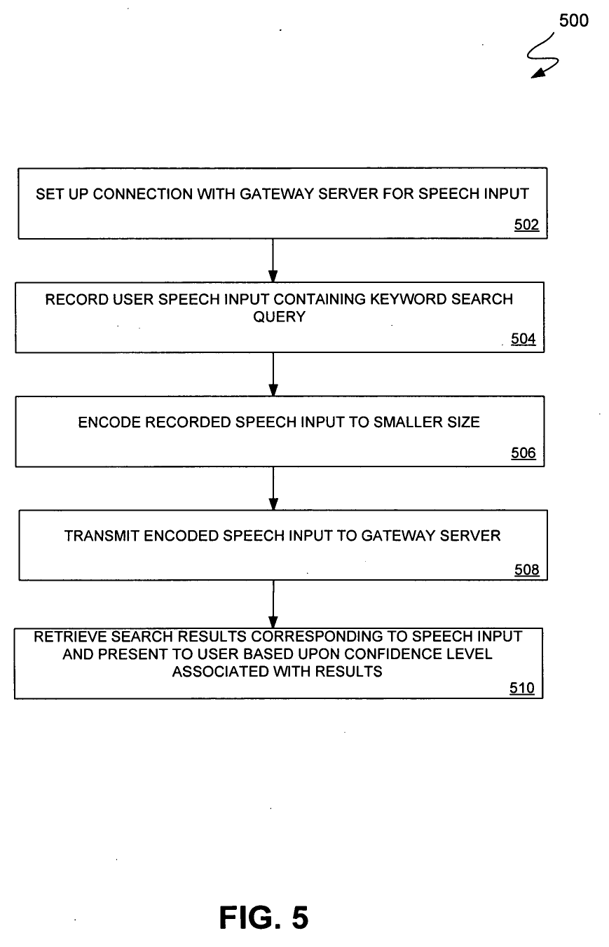

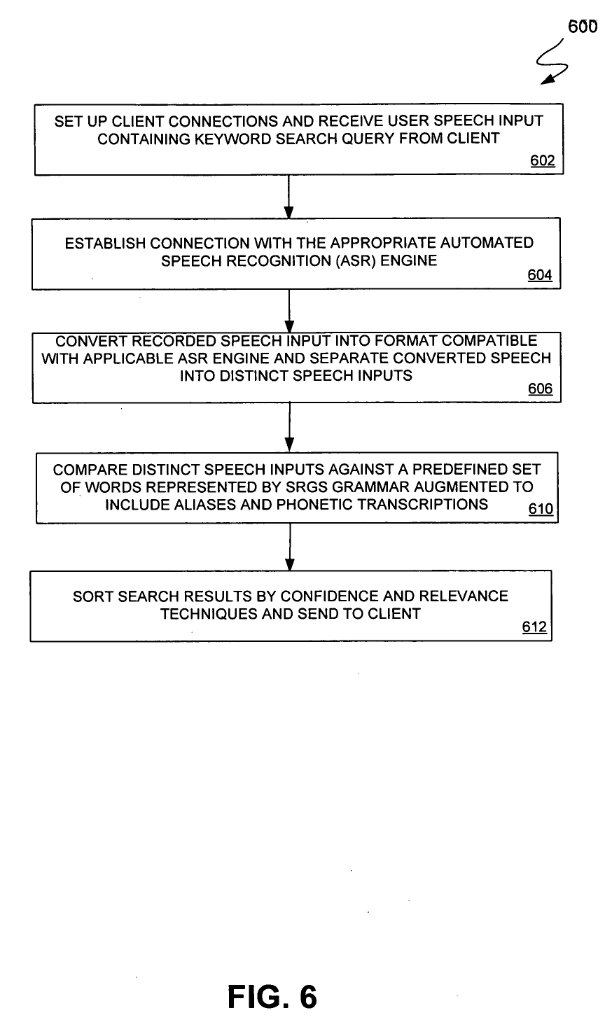

As is described herein, the inventive speech-based search system may be implemented consistent with the client-server architecture described above with reference to FIGS. 1-3. In this regard attention is now directed to FIGS. 5-6, which are flowcharts representative of the operations respectively performed by the client-side application, i.e., veCLIENT, and the gateway server, i.e., veGATEWAY, of the inventive speech-based search system.

Turning now to FIG. 5, one operation performed by the client is the setting up of connections with the veGATEWAY for the streaming of speech input using standard Session Description Protocol (stage 502). Either before or after such connections have been established, the client records speech input provided by the user to the mobile communication device executing the client (stage 504). This recording is typically effected using the standard codec included within the mobile communication device. In certain implementations the file containing the recorded speech input data may be converted to a smaller size using an auxiliary codec compatible with the protocols used by the veGATEWAY in order to reduce the time required to transmit the speech file (stage 506). The speech input data may then be transferred to the veGATEWAY using Realtime Transport Protocol, as is described in the above-referenced copending application Ser. No. 10/840,413 (stage 508). As is described in further detail below, the client then retrieves the search results corresponding to the speech input and presents them to the user via the mobile device based upon the confidence level associated with the results (stage 510).

Referring now to FIG. 6, the veGATEWAY performs setup operations to accept incoming connections from the client using Session Initiation Protocol and to receive the incoming speech input using the Real-time Transport Protocol (stage 602). The veGATEWAY establishes a connection with the appropriate automatic speech recognition (ASR) engine using standard Media Resource Control Protocol (MRCP) interface or a proprietary interface (stage 604). Upon receiving the recorded speech input provided by the client, the veGATEWAY converts it into ULAW format or a format compatible with the selected ASR engine and separates the converted speech into distinct inputs (stage 606). In the exemplary embodiment this separation is effected by detecting silence between each distinct speech input. The distinct speech inputs are then compared against a predefined set of words represented by an SRGS grammar preferably augmented to include aliases and phonetic transcriptions (stage 610). Finally, the word or words within the predefined set of words that are determined to compare favorably or precisely match the distinct speech inputs are sorted by confidence level and relevance techniques in the manner described hereinafter. Selectable links corresponding to network-based content associated with these identified word(s) are then sent to the client for display to the user via the mobile communication device (stage 612).

### Typical Usage Scenario

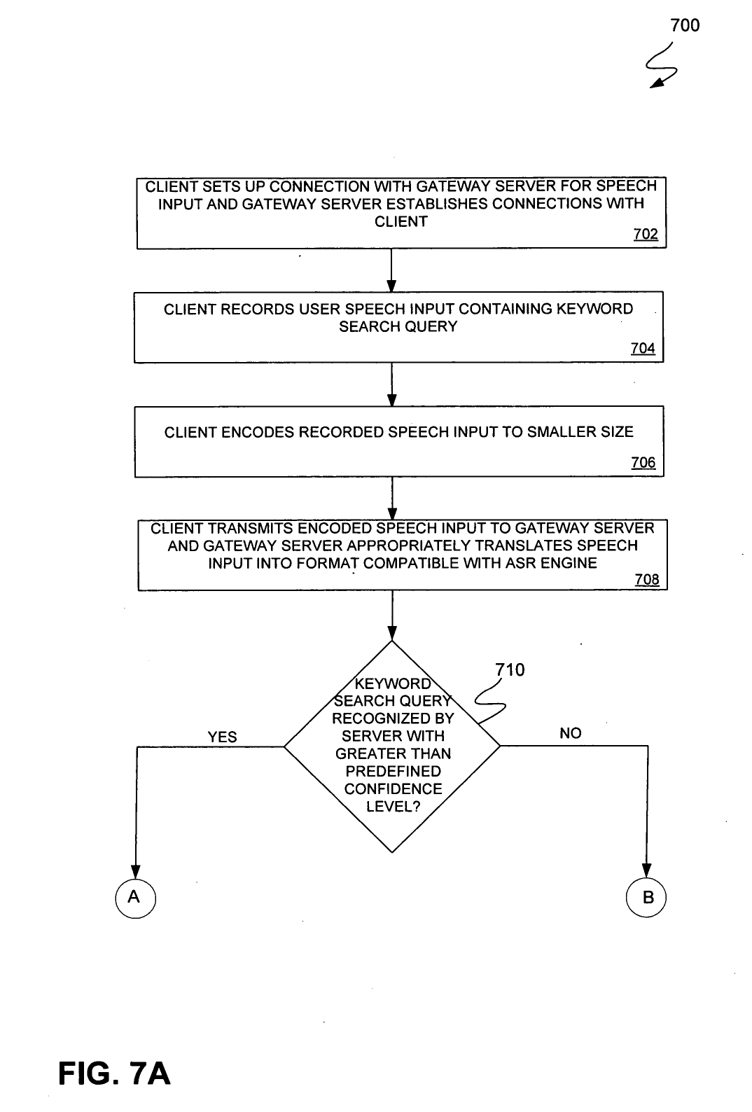

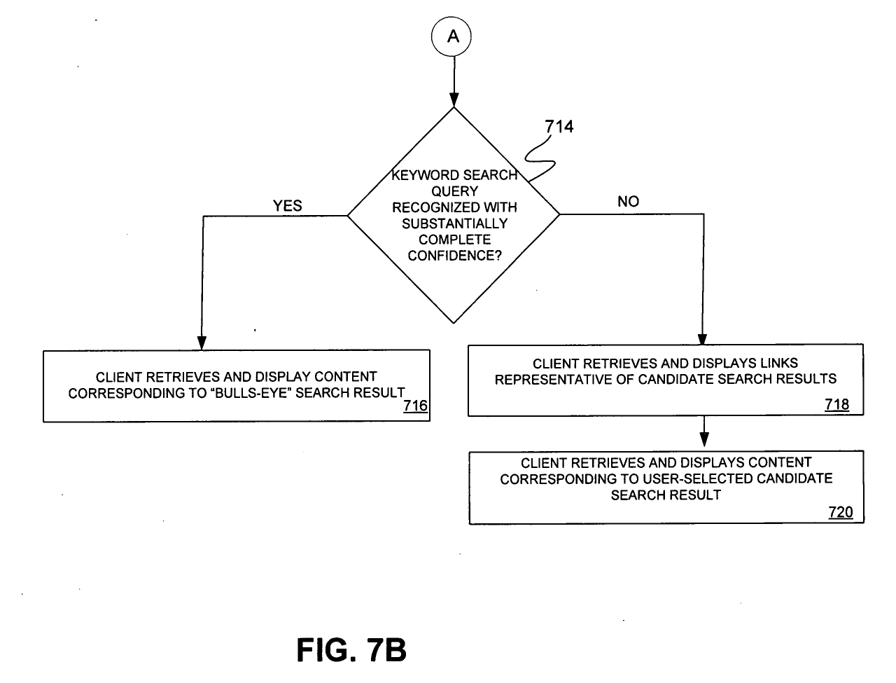

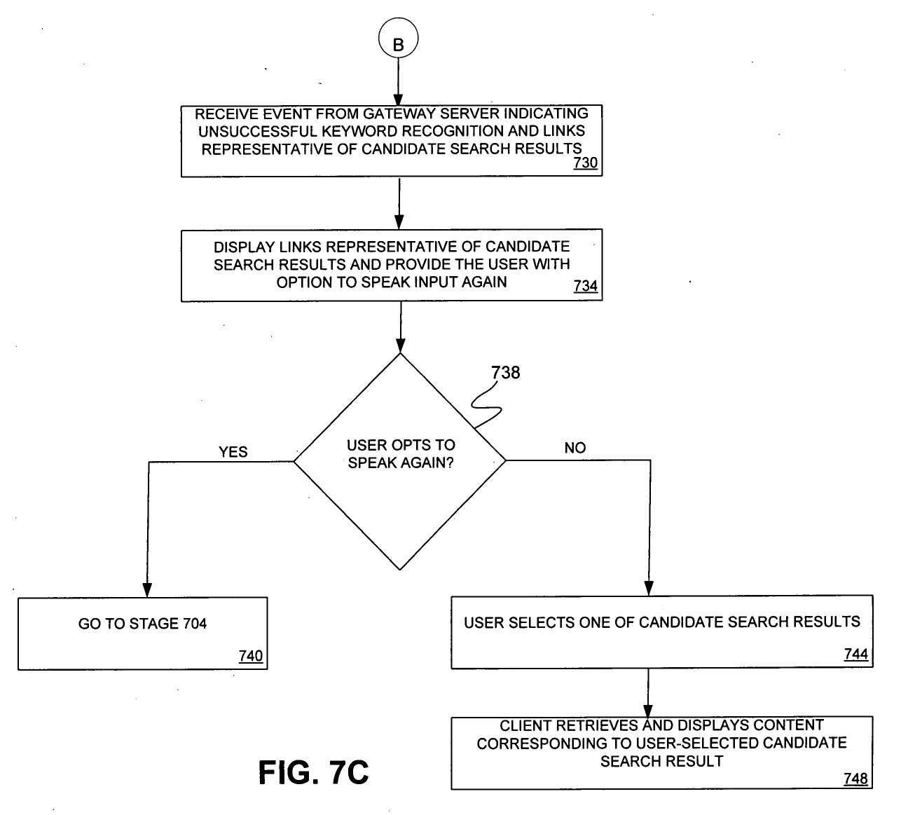

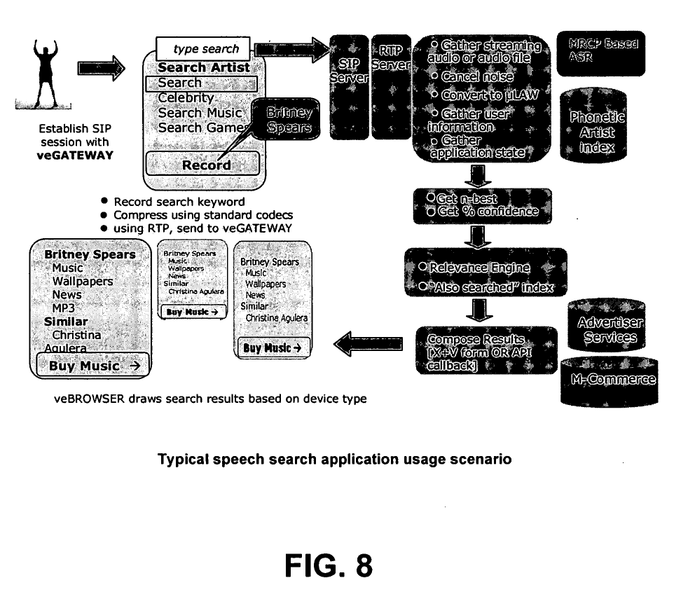

FIGS. 7 and 8 illustrate a typical usage scenario consistent with an embodiment of the speech search method of the present invention. Once a user of a mobile communication device has started execution of the veCLIENT, the veCLIENT causes the mobile device to initiate establishment of a connection with the veGATEWAY and the veGATEWAY establishes connections with the mobile device (stage 702). The veCLIENT then causes the mobile device to display an interface screen indicating to the user that a speech-based search query may be provided via a microphone of the mobile device. In one implementation the user is prompted through this interface to press and hold a “SEND” key or other predefined key while providing this search query, which causes the speech input corresponding to the query to be recorded by the mobile communication device (stage 704). For example, in order to find content related to “Britney Spears”, the user could press and hold the SEND key of the mobile device while speaking “Britney Spears”. The veCLIENT preferably encodes the speech packets corresponding to the search query in a band efficient format for transmission by the mobile device to the veGATEWAY for recognition (stage 706).

Upon receipt at the veGATEWAY, the encoded speech input corresponding to the search query is appropriately translated into a format compatible with the applicable ASR engine (stage 708). If the search query is recognized with greater than a predefined confidence level (stage 710), the veGATEWAY responds to the veCLIENT with an event specifying successful recognition or a “repeat” event. A successful recognition corresponds to either the case where (i) the veGATEWAY is essentially completely confident in its recognition of the search query and provides only a single result (i.e., “bulls-eye” recognition), or (ii) the veGATEWAY has sufficient confidence that the search query corresponds to one of N candidate search results (i.e., the “N-best candidates). If the event relayed back to the veCLIENT is that of a “successful recognition”, the veCLIENT proceeds to find if it is a bulls-eye recognition (stage 714). If so, the veCLIENT does not ask for confirmation from the user. Rather, the veCLIENT causes the mobile communication device to make a call, through the veGATEWAY, to the content server corresponding to the bulls-eye search result and retrieves the requested content (stage 716). If the confidence level in the “successful recognition” is less than necessary for a bulls-eye but higher than a particular threshold, then a list of N-best candidate search results is retrieved by the veCLIENT from the veGATEWAY and presented to the end user for confirmation (stage 718). Following user selection of one of the candidates, the veCLIENT contacts the selected content server and retrieves the appropriate content for display to the user (stage 720).

In case of receipt of a “repeat” event, the veCLIENT receives a set of M (the value of M being configurable via the veCLIENT) most probable candidate search results (stage 730) and displays them to the user along with an option to the user to speak again if desired (stage 734). If the user opts to repeat the search query by speaking again (stage 738), the recorded speech input is sent to the applicable ASR server and recognition of the user input is effected on the basis of both the original and repeated speech inputs in order to increase the likelihood of determining a correct match. Processing then proceeds as described above depending upon the confidence level (e.g., “bulls-eye” recognition) in the results potentially corresponding to the search query.

If the user does not opt to speak again (stage 738), the user selects one of the M most probable candidate search results (stage 744). Following selection of one of these results by the user, the veCLIENT causes content to be retrieved from the corresponding content server (via the veGATEWAY) and displayed to the user (stage 748).

### Speech In and Text Out User Interface

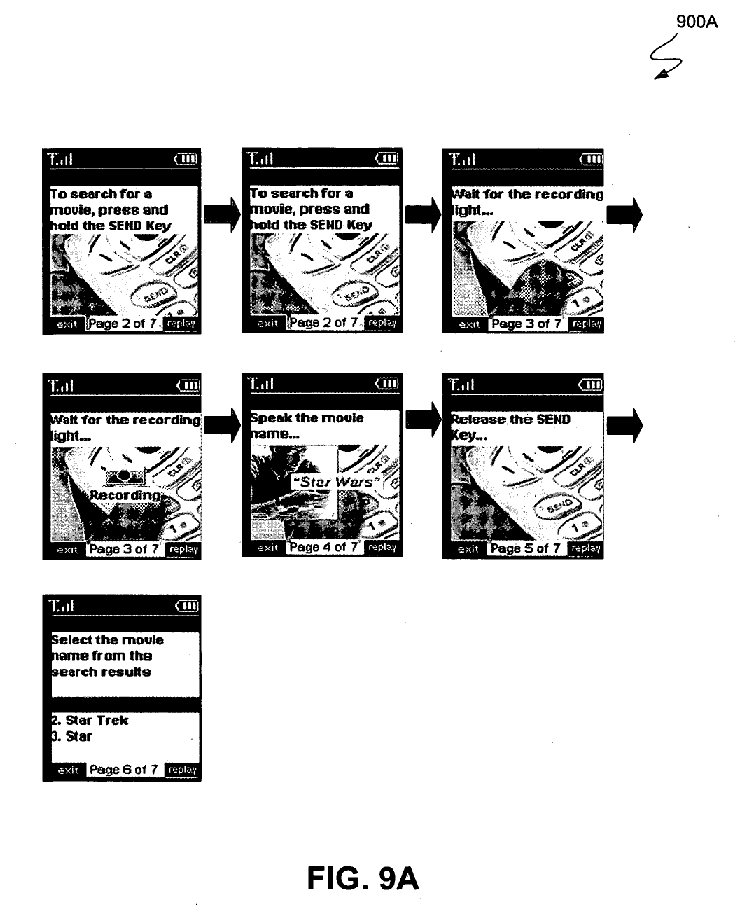

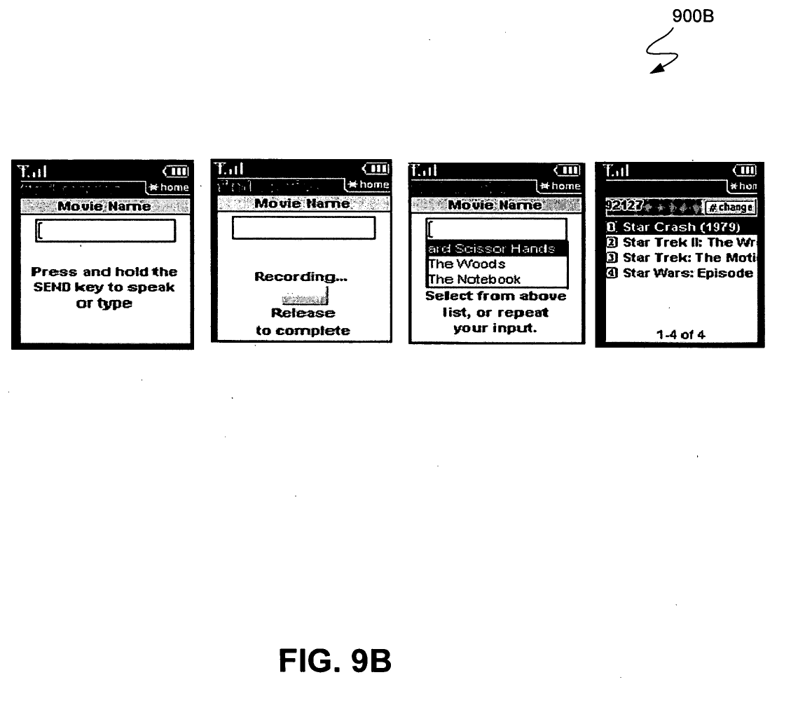

FIGS. 9A and 9B illustrates exemplary sequences of user interface screens 900 presented by a mobile communication device to a user which highlight the “speech in and text out” aspects of the usage scenario described with reference to FIGS. 7 and 8. In this regard it is observed that conventional interactive voice response (IVR) and voice recognition systems receive speech input from a user and confirm this input through a voice-based response. Although this approach may be well-suited for systems leveraging the public switched telephone network (PSTN), it has an inherent drawback in the sense that whenever the user-supplied speech input is not able to be uniquely identified it becomes necessary to perform a cumbersome process of obtaining additional information from the user in order to confirm the correct input. Conversely, the distributed speech-based search application contemplated by embodiments of the invention enable the probable results of the recognition process to be sent back to the user's portable communication device and visually displayed as a list on the screen of the device's screen, thereby effecting a “speech in and text out” approach. This leads to a faster response than is generally possible using conventional IVR or speech recognition techniques, since it obviates the need to send a series of voice packets corresponding to possible candidate search results back to the user's communication device, which can be time-consuming and costly (particularly in the case of wireless networks). As is illustrated by FIG. 9, a set of N-best probable candidate search results corresponding to a spoken search query may be simultaneously visually presented to a user and the desired result immediately selected, thus saving time and expense.

### Speech Input Techniques

The methods used to receive speech input from users may be expected to affect the accuracy of the subsequent speech recognition process. Described below are several speech input method enabling improved speech recognition.

A first speech input method involves pushing by the user of a predefined key (e.g., a “TALK” or “SEND” key) on the user's mobile communication device just prior to speaking and releasing such key when speech input has been completed. In this method the user explicitly determines when the speech input begins and ends.

A second approach to speech input again involves pushing by the user of a predefined key on the user's mobile communication device just prior to speaking and simply ceasing speaking when the speech input has been completed. When this approach is used, the veGATEWAY automatically detects silence at the end of speech input. This approach allows a user to focus on providing speech input and not be concerned with remembering to release the predefined key upon completing such input.

In addition to determining when speech input from a user has been completed, the silence detection capability of the veGATEWAY may be used to improve the user experience in other ways as well. In particular, silence detection may be used to separate the speech input from a user into multiple keywords. For example, a user may say “Pizza San Diego”. The utterance “Pizza San Diego” contains silence after Pizza, which is used to separate the speech input into two keywords (i.e., “Pizza” and “San Diego”). The resultant keywords may then be compared against two separate databases of restaurants and locations. This allows a user to provide multiple keywords in one utterance which are intelligently separated by the veGATEWAY and compared against different databases.

### Mobile Platform Architecture

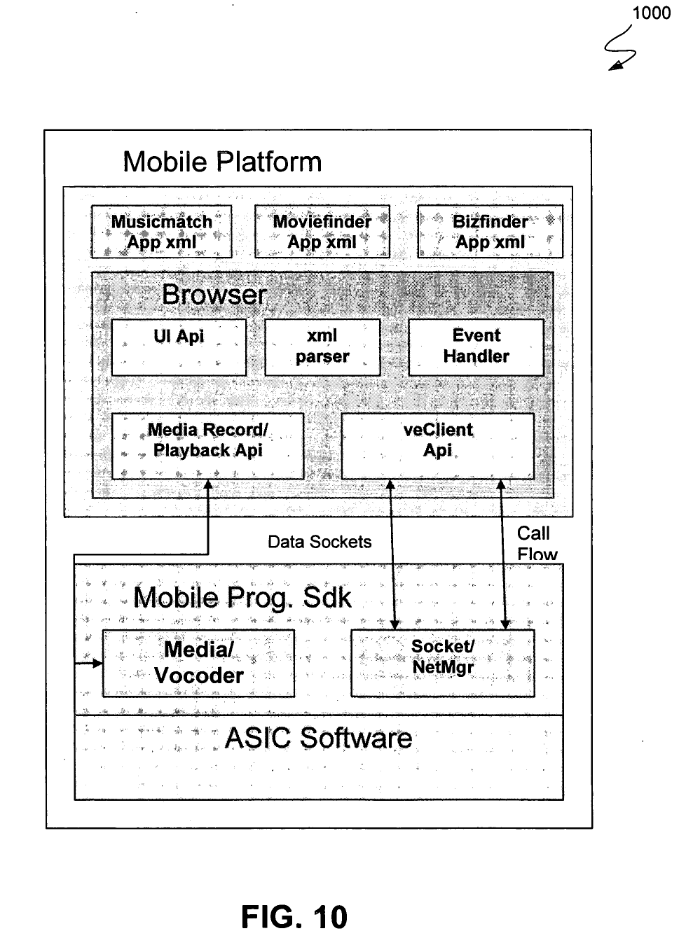

FIG. 10 provides a block diagrammatic representation of the architecture of a portable communication device platform 1000 designed to facilitate the speech search functionality contemplated by the present invention. The platform 1000 is intended to be capable of being used by third party application developers to add speech search capability to their respective applications. This application development is facilitated by a veCLIENT software development kit (SDK) intended for developers unfamiliar with multi-modal application development. As is discussed below, the SDK is intended to let application developers plug “multi-modal” features into their applications easily.

Referring to FIG. 10, the platform 1000 includes a Browser, veCLIENT application programming interface (API), and a Media Record/Playback API. Each of these components is described in detail below.

### Browser

The browser is designed to facilitate the development of mobile handset applications by enabling applications to be written in XML rather than in code. An advantage of defining applications in such manner is that porting is generally not required in order to enable the application operate properly on different portable devices. In the exemplary embodiment the browser is organized in five main modules.

Parser: The parser module parses the application definition file and populates the screen definition structure.

Render: The reader module renders the currently active screen on the handset in a manner which accommodates different physical screen sizes.

Event Handler: The event handler captures all the events and processes them according to the currently active screen.

Script Handler: The script handler manages the interface with veCLIENT.

Decompressor: Due to the limited file space application definition file is present in a compressed format on the device. The job of this module is to decompress it before passing the data to parser module.

### Media Recording/Playback API

Many programming platforms for portable communication devices (e.g., Brew, Symbian, J2ME) provide API's to enable the recording of user speech. Wrappers are built around these API's to provide a simpler API for application developers to use in their application and choose the codecs supported at the veGATEWAY.

### veCLIENT SDK

As mentioned above, the veCLIENT SDK implements a protocol needed to communicate with the veGATEWAY. It does so by exposing a set of simple API's to the application developers. These simple API calls (the calls to recognize the speech input) are translated by the veCLIENT SDK to SIP, RTP protocol messages that are needed to communicate with the veGATEWAY. In the exemplary embodiment the SIP channel is used for call control and the RTP channel is used for transporting media. Upon successful completion of the speech recognition process and the receipt from the veGATEWAY of search results corresponding to the recognized query, the results are returned to the requesting speech search application by veCLIENT. These results, which are in XML format, are parsed and presented to the user by the browser.

### veGATEWAY Adapter Architecture

### Overview

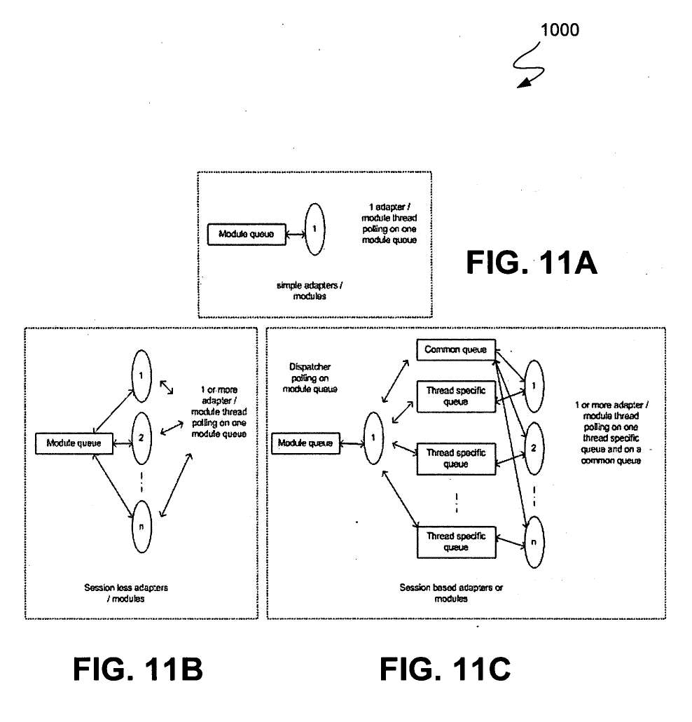

FIGS. 11A-11C provide illustrative representations of various adapter architectures capable of being utilized within the veGATEWAY server. As discussed above, the veGATEWAY server includes a module manager which functions to manage all modules within the server. In the exemplary embodiment each resource-specific adapter runs as a separate independent server module and is uniquely identified by a module ID. The globally unique name of the applicable resource (e.g., an external ASR engine) is mapped to this module id. Each module or adapter can persist between sessions or be “session-based”. The internal implementation of a module will typically depend upon whether or not the module is session-based and whether it runs as a single or multiple threads. Referring to FIGS. 11A-11C, a number of combinations are possible:
1. one module queue and one adapter or module thread (FIG. 11A);
2. one module queue and multiple session less adapter or module threads (FIG. 11B); and
3. one module queue, one dispatcher thread, one common queue and multiple session based adapter or modules and thread specific queues on for each thread (FIG. 11C).

The options depicted in FIGS. 11B and 11C allow a module to “scale up” in order to handle higher load volumes as required.

Based upon the applicable load, a given adapter may be configured to run as one or more java threads within the veGATEWAY server. In order to add an adapter or module to the veGATEWAY server, details specific to the new adapter are added to the configuration file.

In one embodiment each adapter configured to execute as a module through extension of an abstract class VeModule and implementation of the following methods:
1. once( )—any functionality that needs to be executed only once must be implemented in this method. Incase an adapter is configured to as multiple thread this method is invoked only once per adapter/module.
2. init( )—any functionality that needs to invoked at the startup of each adapter/module thread must be implemented in this method. This method is invoked for each thread.
3. process_message( )—All message sent to the queue are handled in this method. So this method is where all the messages are handled.
4. terminate( )—any functionality that needs to be implemented when the adapter is terminated must be implemented in this method. This method is invoked for each thread.

### Connection to Multiple Resources Through Adapters

The veGATEWAY adapter architecture gives the flexibility of providing the services of multiple ASR engines or other resources in a seamless fashion to the application developers. The developer can choose the ASR engine as per their requirements and performance expectations. The multi-modal infrastructure of the veGATEWAY hides the details of accessing particular ASR engines, thereby enabling these resources to be accessed as simply specifying a globally unique name and any associated parameters. In the exemplary embodiment a variant of the SDP protocol is used to specify the resource type, the global resource identifier and any associated query specific parameters. A request from a particular user can be served upon multiple ASR engines in accordance with the type of the request. For example, a user may wish to search for a music artist, which is done through a particular ASR engine (e.g., “ASR engine A”) designed to provide accurate recognition for music artists. Later the same user may want to set or otherwise specify his location by speaking the zip code and utilizing the services of a different ASR engine (e.g., “ASR engine B”) designed to provide accurate recognition for zip code queries. In this scenario the veGATEWAY will intelligently route requests relating to music artists to ASR engine A and route requests relating to zip codes to ASR engine B, thereby improving the experience of the user.

### Dynamic Updating of veGATEWAY Grammar

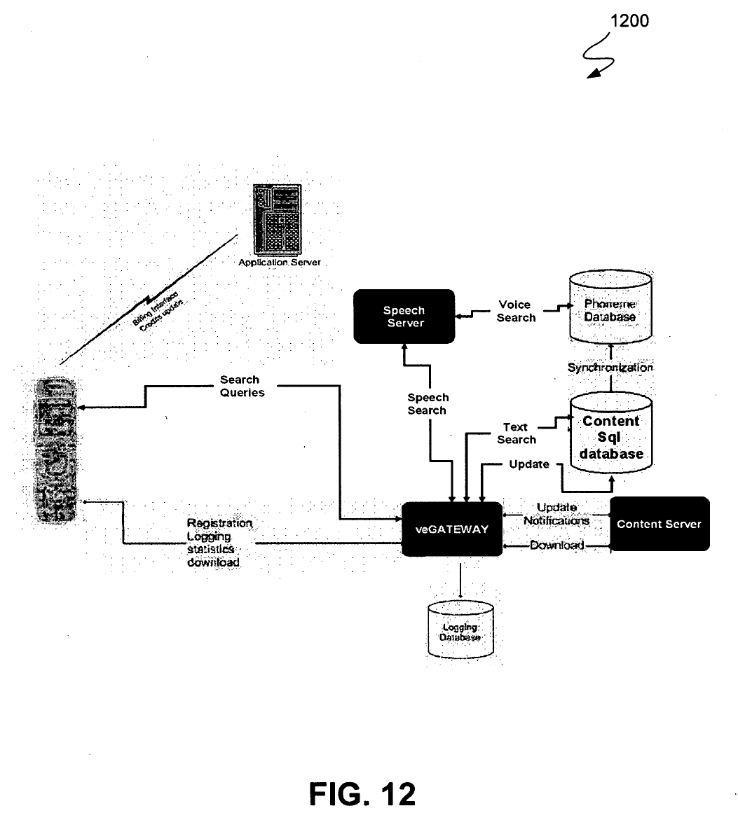

FIG. 12 illustrates the architecture of a system 1200 including a collection of components involved in maintaining a speech search application. In the system 1200, the speech search application comprises a distributed application executed by client and server components. In addition, the veGATEWAY and the content server interact for the purpose of recognizing content corresponding to speech search queries and also for maintaining the application on a continual basis. In this regard the content server is presumed to be dynamic and may change relatively frequently (i.e., it is updated via additions and deletions). Consistent with one aspect of the invention, the veGATEWAY implements an adapter which continually or frequently checks to determine whether the content server has been updated. On receiving a notification of an update, the update portion of the content is downloaded and veGATEWAY updates the content identification database, which is synchronized with a corresponding phonetic representation of this database. Hence, an update of the content server triggers a process pursuant to which the phonetic database is accordingly updated in a corresponding manner.

### Speech Resource Pooling

As discussed above, embodiments of the invention enable multimodal client to access various network resources via the veGATEWAY server. In particular, the multimodal client accesses resources through an application specific interface executed by the client (veCLIENT). Developers may use the veCLIENT API to access substantially any type of resource (e.g., voice, text) using the same set of API calls. The resources are defined at veGATEWAY server, and are specifically designed to serve the requests from multimodal clients for various useful services such as, for example, voice recognition, map generation, driving directions, sending SMS, and the like.

In the exemplary embodiment developers of applications use the veCLIENT API to access resources defined at the veGATEWAY server. An application specific resource also can be created at the server level in order to access desired content.

The accessing of resources via the veGATEWAY server is enabled by the creation of a pool of connection resources within the veGATEWAY. The establishment of such a resource pool is facilitated by the novel adapter architecture of the veGATEWAY, which is described below. The resource pooling approach utilized in embodiments of the invention may be generally characterized as the maintenance of a pool of initialized object resources between the veGATEWAY server and a “backend” or “resource” server, there by reducing the overhead required for accessing the services hosted by the server and enabling faster response time to the client. It is noted that many ASR engines are based upon proprietary protocols running on TCP. In the exemplary embodiment these protocols are implemented as adapters at the veGATEWAY. As the time required to set up the applicable TCP channel and otherwise initialize a connection between a given adapter implemented on the veGATEWAY and a given external ASR engine may be relatively substantial, a resource pool approach is preferably implemented in the veGATEWAY to minimize latencies in the recognition time experienced by a system user. In particular, the resource pool approach is based in part upon the realization that certain steps in the process of initializing connections between adapters on the veGATEWAY and ASR engines are not specific to the recognitions being requested to be performed by such systems. The resource pool approach involves establishing a preconfigured number of channels with the ASR engine and maintaining them in an initialized state; that is, these channels are ready to accept user input for speech. Whenever there is a request for recognition, one of the channels is picked and associated with the client request. If at a time there are more requests than the number of channels connected to the applicable ASR engine, then the requests are queued. This approach advantageously reduces the speech recognition response time and provides faster access to content.

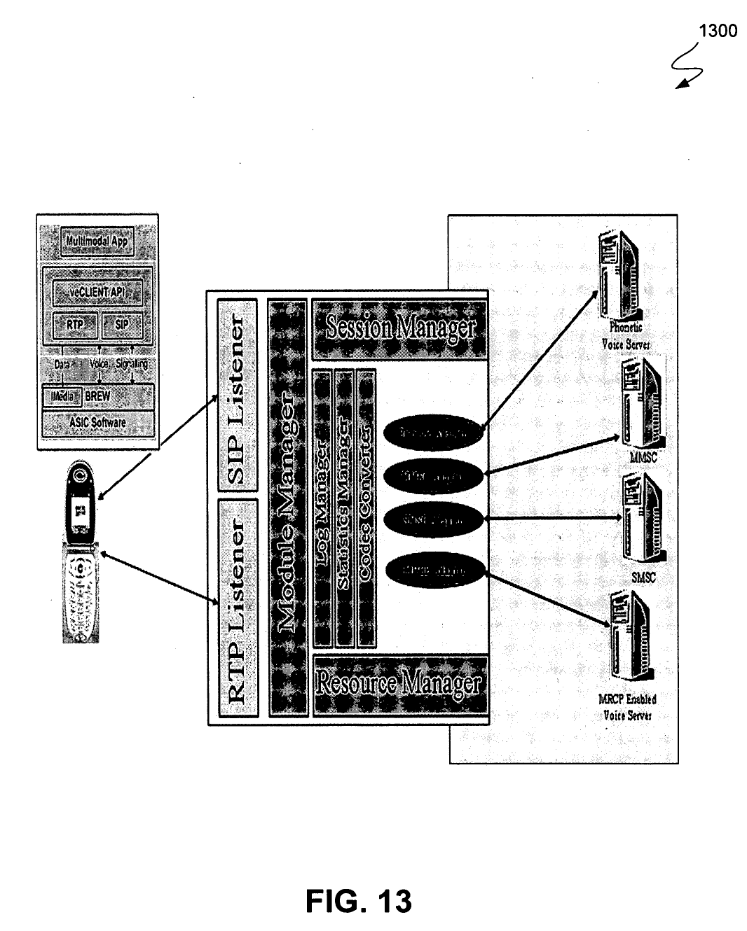

Referring now to FIG. 13, there is provided a high-level overview of the architecture of a multi-modal client-server system 1300 in which the inventive resource pooling approach may be implemented. The multimodal system 1300 includes a veGATEWAY server and a veCLIENT implemented on a portable communication device. The veGATEWAY server includes a resource manager module for managing a pool of object-oriented interface adapters, each of which is paired with an external resource such as (1) a voice server (2) a data server or (3) an enterprise server. In the exemplary embodiment each object-oriented adapter interface comprises classes including a voice server access class, data access class and related methods implemented consistent with the present invention. In general, there exists at least one object within each adapter for retrieving the properties of an external resource and creating the adapter object based upon these properties in order to facilitate establishment of a connection to the resource. In addition to establishing such a connection, a given adapter may initialize the resource to a particular state in accordance with the properties of the adapter. The adapter object of the resource contains a connection manager method to instantiate the interface, create a connection to the resource and thereafter call other methods to initialize the voice and/or data resource. Methods are also called in order to effectively place the resource into an object pool such that it may be used in response to incoming client requests for the resource. An adapter object also typically contains methods to access and execute resources, retrieve the results of such execution, and disconnect from the resource.

In order to improve performance of the system 1300, the resource manager module may establish resource connection pools of different types capable of being accessed via a common interface. In one embodiment the number of resource objects in a particular pool at a given point of time may be adjusted by the resource manager module based upon the applicable load conditions.

In the exemplary embodiment the resource manager module is comprised of the following sub-modules; namely, a Property Manager, Pool Manager, Pool and Connection. The Property Manager reads the properties specified for each resource. The Pool Manager maintains one or more resource object pools which are initialized as specified in the applicable property file and connected to one or more backend servers. The Pool sub-module maintains one or more resource objects (as specified in the Pool configuration) to a specific backend resource. For example, the Pool sub-module may maintain resource objects such as Pool name, NetworkAddress/Port of the Backend server, Minimum number of connections in the Pool, Maximum number of connections in the Pool, Pending request Count, Idle connection time, and Initialization state. Finally, the Connection sub-module identifies a unique channel used to communicate with a specific backend resource.

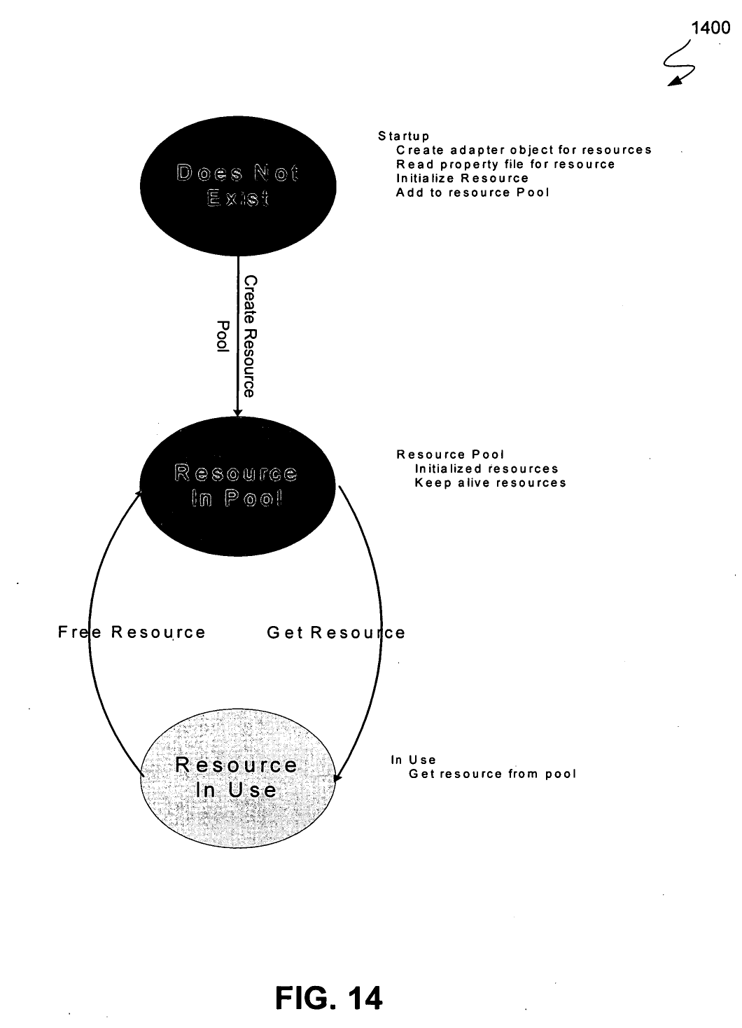

Turning now to FIG. 14, there is provided a state diagram 1400 illustrating various aspects of a server-side resource pooling approach consistent with the present invention. In the exemplary embodiment two types of resource pooling can be done at the server level to optimize and reduce response time. The first type involves maintaining a pool of initialized objects connected to a backend server but not bound to a particular resource name. These objects can be used for any resource on the server based upon the client request. The second type of pooling involves maintaining an object pool of resources initialized up to a particular state and associated with a specific resource name. Resources are initialized at the startup and can be taken from the pool in response to a client request. After completing a client request, the object used to complete the request is reinitialized to it previous state before being returned back to the pool.

### Other Search Speed and Accuracy Enhancement Methodologies

### Codec Conversion

In accordance with another aspect of the invention, “codec conversion” may be effected within either or both of the client and server components executing the inventive speech search application. It is observed that many existing speech recognition systems are to recognize speech input encoded in the uLAW format, which is the format in which speech is transmitted over the PSTN channels. However, mobile phones and other portable communication devices operative in digital wireless communication systems tend to use band-efficient codecs for the transmission of speech. In this regard the size of speech input in uLaw format is generally many times greater than the size of speech of the same informational content produced by codecs typically used for compressing speech on mobile phones. This translates to potentially appreciable increased transmission delay within digital wireless communication systems.

Existing speech recognition engines are not capable of processing the speech encoded in these bandwidth-efficient formats. Accordingly, a codec converter module is preferably used in the veGATEWAY to convert the input speech into uLAW format. The veGATEWAY automatically detects the incoming speech format coming from the client device and uses an appropriate codec converter to convert the incoming speech data into ULAW format. The resultant ULAW data is then passed to the ASR engine for recognition.

Certain mobile communication devices do not provide the capability of compressing speech using band-efficient codecs, and tend to record speech in a native, uncompressed format. However, sending data from such a mobile communication device to a server in an uncompressed format will generally be expensive and substantially lengthen the response time of voice-based applications. In order to address this issue, in one embodiment each veCLIENT is configured with a client-side codec converter to convert uncompressed, recorded speech data into a compressed format prior to transmitting it to the veGATEWAY. It follows that in this embodiment both the veCLIENT and veGATEWAY include codec converters.

### Aliasing

Although the models employed by existing ASR engines generally take into account the differences in pronunciation of words by various ethnic groups, such models are not known to utilize search databases containing alternative versions or “aliases” of the words catalogued in the database. It is a feature of embodiments of the speech search system of the invention to incorporate “domain-specific” knowledge, such as aliases, into the search database in order to facilitate proper recognition. For example, if a user desires to recognize “Automobile Association of America”, the user could conceivably provide an input of “AAA” or “Triple A”, the latter of which is a popular colloquial term representative of “Automobile Association of America”. Phonetically “Triple A” is completely different from “Automobile Association of America”, but the intent of a user uttering “Triple A” would be quite clear to most listeners. Accordingly, the capability to incorporate domain knowledge such as this into a search database would likely substantially improve recognition performance. One way to incorporate such knowledge into the search database is by “aliasing” some or all of the entries of the database; that is, by associating within the database an alternate or more popular colloquial representation of each database entry being aliased. Accordingly, in one embodiment of the inventive speech search process when either of the representations is used, the actual entry is returned.

Aliasing may also be employed in representing search database entries having elements such as “The”, which are often not employed by users when uttering search queries. For example, a user searching for the movie “The Matrix” could in all probability refer to it simply as “Matrix”, which is phonetically completely different from the “The Matrix”. Accordingly, absent the use of the aliasing techniques of the present invention, the use of search queries phonetically different from, but substantively identical to, the entries in a search database does not generally yield positive recognition results.

Aliasing can also be added to specify some domain specific or language pronunciations which cannot be found in a general language or pronunciation model. Some foreign languages have similar script to English but are characterized by quite different pronunciations. For example, a user searching for the play “Les Miserables” would generally utilize the French, rather than English, pronunciation when uttering the search term. It follows that an alternate “English” phonetic representation for this entry which sounds more closely to its actual French pronunciation could be added to the search database in order to improve recognition accuracy.

### Popularity Index

Existing ASR engines are generally agnostic to the content used to recognize user-supplied speech input. That is, all possible candidates are equally associated with such input as long as the phonetic proximity of all candidates to the input is the same. In accordance with one aspect of the invention, a popularity index is employed in association with the search database to differentiate such content. For example, consider the case in which a speech search application configured to search for content (e.g., music or “wall paper”) related to artists is provided with an input of “Britney”. The search database may have an entry for “Britney Spears” as well as for “Britney Murphy”. However, associating popularity index with each of these entries based upon the type and quantity of content associated with each enable these entries to be ordered in a rational manner. Moreover, the popularity index associated with a given artist may be dynamically updated as information pertaining to such artist is accessed more frequently. A popularity index may also be designed to be a function of time. For example, when searching a database of movie listings, an input of “Star” can lead to search results including a number of different episodes of “Star Wars” or “Star Trek”. However, at a point in time in which the movie “Star Wars: Episode 3” had been recently released, a greater popularity index could be assigned to that entry and all its associated entries.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following Claims and their equivalents define the scope of the invention.

1. A method, comprising:
receiving, at a portable communication device, speech input containing a keyword;
sending, from the portable communication device, data representative of the speech input to a server;
receiving, at the portable communication device, information relating to a plurality of candidate results corresponding to the keyword; and
displaying, through an interface of the portable communication device, a list of selectable links through which network-based content associated with the plurality of candidate results may be accessed.

2. The method of claim 1 further including displaying a visual representation of network-based content retrieved from a network in response to selection of one of the selectable links.

3. The method of claim 1 further including recording, at the portable communication device, the speech input.

4. The method of claim 3 wherein the recording is initiated upon selection of a predefined key located on the portable device.

5. The method of claim 4 further including continuing the recording for as long as the predefined key remains selected and terminating the recording upon release of the predefined key.

6. The method of claim 3 further including encoding input data generated during the recording of the speech input so as to generate the data representative of the speech input.

7. The method of claim 1 further including:
receiving, at the portable communication device, a message indicating that the keyword was not recognized at the server, and
generating, at the portable communication device, a user prompt to repeat the speech input.

8. The method of claim 7 further including:
receiving, at the portable communication device, additional speech input containing the keyword, and
sending, from the portable communication device, data representative of the additional speech input to the server.

9. The method of claim 1 wherein the speech input is received by the portable communication device during display through the interface of the portable communication device of a search screen corresponding to a category of information and wherein the list of selectable links correspond to network-based content pertaining to the category of information.

10. A method, comprising:
receiving, at a portable communication device, speech input containing a keyword;
sending, from the portable communication device, data representative of the speech input to a server;
receiving, at the portable communication device, content from a network which corresponds to the keyword; and
rendering, through a display of the portable communication device, a visual representation of the content.

11. The method of claim 10 further including recording, at the portable communication device, the speech input.

12. The method of claim 11 wherein the recording is initiated upon selection of a predefined key located on the portable device.

13. The method of claim 10 further including:
receiving, at the portable communication device, a message indicating that the keyword was not recognized at the server, and
generating, at the portable communication device, a user prompt to repeat the speech input.

14. The method of claim 13 further including:
receiving, at the portable communication device, additional speech input containing the keyword, and
sending, from the portable communication device, data representative of the additional speech input to the server, wherein the server utilizes both the speech input and the additional speech input in determining the keyword.

15. The method of claim 10 wherein the speech input is received by the portable communication device during rendering through the display of the portable communication device of a search screen corresponding to a category of information and wherein the content from the network pertains to the category of information.

16. A method, comprising:
receiving, at a gateway server, input data from a portable communication device representative of speech input received by the portable communication device;
processing the input data to identify one or more input keywords;
identifying, based upon the one or more input keywords, a plurality of candidate results potentially corresponding to the one or more input keywords; and
sending, to the portable communication device, information enabling display of a list of selectable links through which network-based content associated with the plurality of candidate results may be accessed.

17. The method of claim 16 wherein the identifying includes:
performing a comparison of the one or more input keywords to a predefined set of words,
determining, based upon the comparison, confidence levels associated with the matching of the predefined set of words to the one or more input keywords, and
deriving the plurality of candidate results from the predefined set of words based upon the confidence levels.

18. The method of claim 16 further including:
receiving, at the gateway server, additional input data from the portable communication device representative of additional speech input received by the portable communication device;
processing the additional input data to identify at least one additional input keyword, wherein the identifying of the plurality of candidate results is based upon both the one or more input keywords and the at least one additional input keyword.

19. The method of claim 16 further comprising:
receiving, from the portable communication device, an indication of user selection of one of the selectable links;
requesting, from a content server, selected content corresponding to the one of the selectable links;
receiving, at the gateway server, the selected content; and
sending, to the portable communication device, the selected content for display.

20. A method, comprising:
receiving, at a gateway server, input data from a portable communication device representative of speech input received by the portable communication device;
processing the input data to identify one or more input keywords;
identifying, based upon the one or more input keywords, content corresponding to the one or more input keywords;
issuing, to a content server, a request for the content; and
sending, to the portable communication device, the content for display.

21. The method of claim 20 wherein the identifying includes:
performing a comparison of the one or more input keywords to a predefined set of words,
determining, based upon the comparison, that at least one of the predefined set of words matches the one or more input keywords wherein the content is associated with the at least one of the predefined set of words.

22. A portable communication device, comprising:
a communication portion which allows receiving of speech input containing a keyword, sending data representative of the speech input to a server, and receiving of information relating to a plurality of candidate results corresponding to the keyword; and
a user interface portion containing a display capable of rendering a list of selectable links through which network-based content associated with the plurality of candidate results may be accessed.

23. The portable communication device of claim 22 wherein the user interface portion further includes a recording component configured to record the speech input.

24. A portable communication device, comprising:
a communication portion which allows receiving of speech input containing a keyword, sending data representative of the speech input to a server, and receiving content from a network corresponding to the keyword; and
a user interface portion containing a display capable of rendering a visual representation of the content.

25. A gateway server, comprising:
a communication portion which allows receiving of input data from a portable communication device representative of speech input received by the portable communication device; and
a processing portion configured to process the input data to identify one or more input keywords and identify, based upon the one or more input keywords, a plurality of candidate results potentially corresponding to the one or more input keywords;
wherein the communication portion sends information to the portable communication device enabling display of a list of selectable links through which network-based content associated with the plurality of candidate results may be accessed.

26. The gateway server of claim 25 wherein the communication portion is further configured to:
receive, from the portable communication device, an indication of user selection of one of the selectable links;
request and receive, from a content server, selected content corresponding to the one of the selectable links; and
send, to the portable communication device, the selected content for display.

27. A gateway server, comprising:
a communication portion which allows receiving of input data from a portable communication device representative of speech input received by the portable communication device; and
a processing portion configured to process the input data to identify one or more input keywords and identify, based upon the one or more input keywords, requested content corresponding to the one or more input keywords;
wherein the communication portion issues, to a content server, a request for the requested content and sends the requested content to the portable communication device for display.

28. The gateway server of claim 27 wherein the processing portion is further configured to perform a comparison of the one or more input keywords to a predefined set of words representative of network-based content and determine, based upon the comparison, that at least one of the predefined set of words matches the one or more input keywords wherein the at least one of the predefined set of words is representative of the requested content.

29. A method, comprising:
receiving speech input through an audiovisual interface of a communication device; and
displaying, through the audiovisual interface, content acquired from a network based upon the speech input.

30. The method of claim 29 further including recording, at the communication device, the speech input.

31. The method of claim 30 wherein the recording is initiated upon selection of a predefined key located on the communication device.

32. The method of claim 31 further including continuing the recording for as long as the predefined key remains selected and terminating the recording upon release of the predefined key.

33. The method of claim 29 further including receiving, at the communication device, additional speech input wherein the content acquired from the network is based upon both the speech input and the additional speech input.

34. A gateway server, comprising:
a communication portion which allows receiving of input data from a portable communication device representative of speech input received by the portable communication device;
a set of resource adapters configured to maintain a plurality of initialized network connections with a corresponding plurality of external servers; and
a gateway controller operative to assign the input data to one of the initialized network connections;
wherein the communication portion sends information corresponding to the input data to one of the external servers over the one of the initialized network connections.

35. The gateway server of claim 34 wherein each of the resource adapters implements a protocol equivalent to a protocol implemented by at least one of the external servers.

36. The gateway server of claim 34 wherein the communication portion further allows receiving of input data from an additional portable communication device representative of additional speech input received by the additional portable communication device, the gateway server further including a queue for queuing the input data from the additional portable communication device.
